(19) United States
(12) Patent Application Publication
(10) Pub. No.: US 2025/0123898 A1
(43) Pub. Date: Apr. 17, 2025

(54) METHOD AND APPARATUS FOR EXECUTING ARTIFICIAL INTELLIGENCE SERVICE BASED ON VIRTUAL INFRASTRUCTURE

(71) Applicant: ELECTRONICS AND TELECOMMUNICATIONS RESEARCH INSTITUTE, Daejeon (KR)

(72) Inventors: Hyun-Hwa CHOI, Daejeon (KR); Dae-Won KIM, Daejeon (KR); Sun-Wook KIM, Hwaseong-si (KR); Su-Min JANG, Sejong-si (KR); Jae-Geun CHA, Daejeon (KR)

(21) Appl. No.: 18/441,070

(22) Filed: Feb. 14, 2024

(30) Foreign Application Priority Data
Oct. 17, 2023 (KR) 10-2023-0138219

(51) Int. Cl. G06F 9/50

(52) U.S. Cl. CPC G06F 9/5055

(57) ABSTRACT

Disclosed herein is a method for executing Artificial Intelligence (AI) services based on virtual infrastructures. The method includes configuring the sharing type of a computational processing unit, executing an AI service based on a virtual infrastructure using requirements for the AI service and information about the sharing type of the computational processing unit, and performing optimization for the AI service.

### CROSS REFERENCE TO RELATED APPLICATION

This application claims the benefit of Korean Patent Application No. 10-2023-0138219, filed Oct. 17, 2023, which is hereby incorporated by reference in its entirety into this application.

### BACKGROUND OF THE INVENTION

### 1. Technical Field

The present disclosure relates to technology for executing multiple AI services using a GPU installed in a computing server.

More particularly, the present disclosure relates to technology for enabling AI services based on virtual machines or containers to share a GPU and deploying the AI services to form an optimal combination for simultaneous execution thereof in order to make better use of the GPU.

### 2. Description of Related Art

As GPU specifications have recently become higher, there have been cases where GPU resources (memory and compute cores) are not fully utilized by a corresponding AI service. For example, according to specifications of H100 PCIe of NVIDIA, H100 PCIe provides 80 GB of memory and 2 TB of memory bandwidth and provides 756 Tera FLOPS (TFLOPS) in TensorFloat-32 (TF32). It is reported that, when Deep Neural Network (DNN) inference queries of DjiNN and Tonic workload suite were performed on a PCIe-based P100 (up to 18.7 TFLOPS, 16 GB of memory, and 732 GB/s of bandwidth) in Alibaba data center, 10% of GPU memory was consumed for a single inference query, and only 50% of GPU memory was consumed for 128 inference queries.

For this reason, technology for executing multiple AI services by sharing a GPU is in the spotlight. Like CPUs, GPUs also support a time-sharing scheduler, but because a GPU context is usually much larger than a CPU context, the cost for context switching is high, and thus it has not been widely used. Meanwhile, virtualization technology for partitioning a single GPU to form multiple virtual GPUs has also been developed and increasingly used. These GPU sharing technologies are usually implemented in a static form by specifying the method of sharing a GPU mounted on a computing server in advance and configuring an environment before virtual infrastructures of AI services are deployed (executed).

In order to execute AI services in response to multiple user requests in a cluster of one or more computing servers, a dynamic method and apparatus capable of ensuring service performance and optimally deploying and executing virtual infrastructures of AI services by configuring and changing a method of sharing a GPU so as to improve the utility of the GPU is required.

### DOCUMENTS OF RELATED ART

(Patent Document 1) Korean Patent No. 10-2032521, titled “Method and system for GPU virtualization based on container”.

### SUMMARY OF THE INVENTION

An object of the present disclosure is to detect the amount of resources required for executing AI services and establish an optimal GPU sharing policy, thereby increasing a utilization rate.

Another object of the present disclosure is to increase the utilization rate of a GPU by making an optimal combination when multiple AI services are executed.

In order to accomplish the above objects, a method for executing AI services based on virtual infrastructures according to an embodiment of the present disclosure includes configuring a sharing type of a computational processing unit, executing an AI service based on a virtual infrastructure using requirements for the AI service and information about the sharing type of the computational processing unit, and performing optimization for the AI service.

Here, the sharing type of the computational processing unit may include a type in which the resource of the computational processing unit is shared by multiple virtual infrastructures and a type in which virtual computational processing units are generated by partitioning the resource of the computational processing unit.

Here, the sharing type of the computational processing unit may include a first type in which the entire computational processing unit supports AI services of multiple virtual infrastructures, a second type in which the entire computational processing unit supports AI services of multiple virtual infrastructures but the AI services of the multiple virtual infrastructures are integrated into a single context, a third type in which multiple virtual computational processing units are generated by partitioning the memory of the computational processing unit, and a fourth type in which multiple virtual computational processing units are generated by partitioning the memory and cores of the computational processing unit.

Here, the requirements for the AI service may include information about a resource of a computational processing unit, information about the model of the AI service, information about the type of a virtual infrastructure, and whether isolated execution is required.

Here, the type of the virtual infrastructure may include a virtual machine or a container.

Here, performing the optimization may comprise performing optimization for partitioning of the computational processing unit, a batch size, a combination of AI models to be simultaneously executed, and the sharing type of the computational processing unit.

Here, executing the AI service may comprise inserting the AI service into a ready queue when a resource of a computational processing unit satisfying the requirements for the AI service is not present.

Here, performing the optimization may comprise determining whether to perform optimization based on the utilization rate of the computational processing unit and whether an AI service waiting in the ready queue is present.

Here, performing the optimization may comprise performing AI service migration and, when necessary, changing the sharing type of the computational processing unit.

Here, performing the optimization may comprise, when the utilization rate of the computational processing unit is greater than a first threshold value, redeploying an AI service being executed on the computational processing unit on another computational processing unit.

Here, performing the optimization may comprise, when the throughput of AI services simultaneously being executed on the computational processing unit is less than a second threshold value, performing migration of the AI service.

Also, in order to accomplish the above objects, an apparatus for executing AI services based on virtual infrastructures according to an embodiment of the present disclosure includes a type configuration unit for configuring a sharing type of a computational processing unit, a service execution unit for executing an AI service based on a virtual infrastructure using requirements for the AI service and information about the sharing type of the computational processing unit, and an optimization unit for performing optimization for the AI service being executed.

Here, the sharing type of the computational processing unit may include a type in which the resource of the computational processing unit is shared by multiple virtual infrastructures and a type in which virtual computational processing units are generated by partitioning the resource of the computational processing unit.

Here, the sharing type of the computational processing unit may include a first type in which the entire computational processing unit supports AI services of multiple virtual infrastructures, a second type in which the entire computational processing unit supports AI services of multiple virtual infrastructures but the AI services of the multiple virtual infrastructures are integrated into a single context, a third type in which multiple virtual computational processing units are generated by partitioning the memory of the computational processing unit, and a fourth type in which multiple virtual computational processing units are generated by partitioning the memory and cores of the computational processing unit.

Here, the requirements for the AI service may include information about a resource of a computational processing unit, information about the model of the AI service, information about the type of a virtual infrastructure, and whether isolated execution is required.

Here, the type of the virtual infrastructure may include a virtual machine or a container.

Here, the optimization unit may perform optimization for partitioning of the computational processing unit, a batch size, a combination of AI models to be simultaneously executed, and the sharing type of the computational processing unit.

Here, the service execution unit may insert the AI service into a ready queue when a resource of a computational processing unit satisfying the requirements for the AI service is not present.

Here, the optimization unit may determine whether to perform optimization based on the utilization rate of the computational processing unit and whether an AI service waiting in the ready queue is present.

Here, the optimization unit may perform AI service migration, and may change the sharing type of the computational processing unit when necessary.

Here, when the utilization rate of the computational processing unit is greater than a first threshold value, the optimization unit may redeploy an AI service being executed on the computational processing unit on another computational processing unit.

Here, when the throughput of AI services simultaneously being executed on the computational processing unit is less than a second threshold value, the optimization unit may perform migration of the AI service.

Also, in order to accomplish the above objects, a method for supporting execution of AI services based on virtual infrastructures according to an embodiment of the present disclosure includes executing AI services based on virtual infrastructures using requirements for the AI services and information about a combination of AI models to be simultaneously executed and performing optimization for the AI services.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is an example of execution of AI services based on virtual infrastructures;

FIG. 2 is a flowchart illustrating a method for executing AI services based on virtual infrastructures according to an embodiment of the present disclosure;

FIG. 3 is a block diagram illustrating an apparatus for enhancing GPU utilization according to an embodiment of the present disclosure;

FIG. 4 is a block diagram illustrating a global GPU-serving controller in detail;

FIG. 5 is a block diagram illustrating a local GPU-serving controller in detail;

FIG. 6 is a view illustrating a GPU sharing policy;

FIG. 7 is a block diagram illustrating an AI service profiler in detail;

FIG. 8 is an example of execution of AI services based on GPU sharing;

FIG. 9 is an example of execution of AI services based on GPU sharing after global optimization;

FIG. 10 is a block diagram illustrating an apparatus for executing AI services based on virtual infrastructures according to an embodiment of the present disclosure; and

FIG. 11 is a view illustrating the configuration of a computer system according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

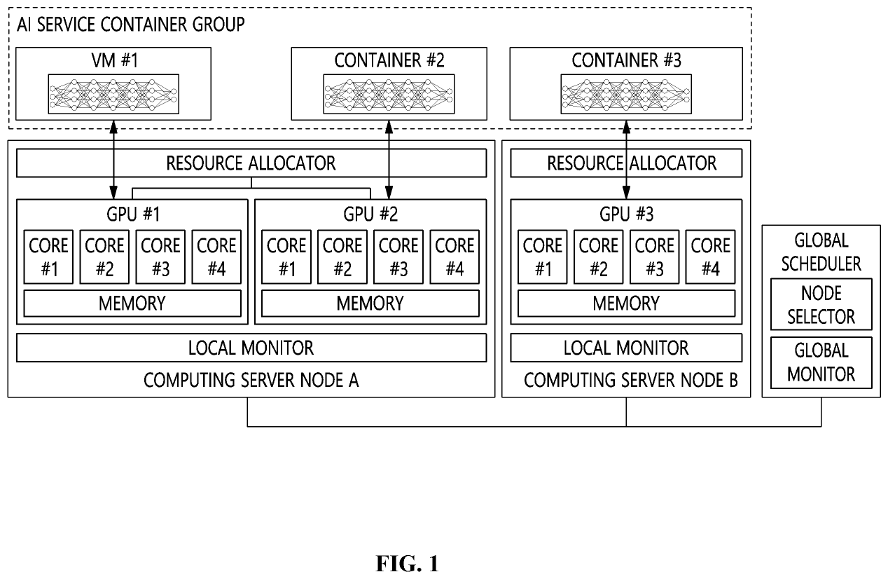

FIG. 1 is an example of execution of AI services based on virtual infrastructures.

Referring to FIG. 1, a single GPU may be allocated to be exclusively used only for a virtual infrastructure (a container or a virtual machine) for executing an AI service, such as situation awareness through image analysis, surrounding surveillance, or the like. In response to a request from a user to execute an AI service, a global scheduler acquires information about resource allocation and resource and service state information collected by the local monitor of each computing node in a cluster of one or more computing server nodes, and the node selector of the global scheduler selects a computing server node having an available resource based on the acquired information.

The resource allocator of the corresponding computing server node receives a request to execute the AI service from the node selector and executes the AI service by allocating a local resource. Here, the AI service may be executed based on a virtual infrastructure of a container or a virtual machine, and the image of the virtual infrastructure may be accessed through common storage in the cluster or external storage.

Hereinafter, embodiments of the present disclosure will be described in detail with reference to the accompanying drawings. In the following description of the present disclosure, the same reference numerals are used to designate the same or similar elements throughout the drawings, and repeated descriptions of the same components will be omitted.

When multiple AI services are executed on a single GPU, the method according to an embodiment of the present disclosure may perform global optimization for the GPU in a cluster when the utilization rate of the GPU or the service throughput is low. The global optimization may comprise dynamically changing a GPU sharing policy based on four types of isolation of resources in the GPU and performing service migration and execution of additional AI services.

Also, an environment in which additional AI services are able to be executed is constructed by collecting multiple available GPU resource fragments through AI service migration (that is, virtual infrastructure migration) and by changing the GPU sharing policy, whereby the GPU utilization rate of a computing server cluster may be increased. Here, the sharing policy of each GPU in the computing server may be dynamically changed and the AI service may be executed.

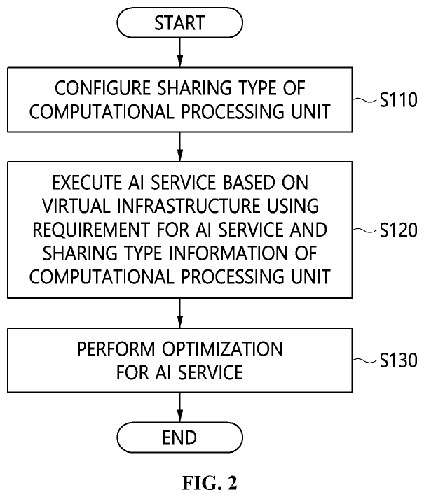

FIG. 2 is a flowchart illustrating a method for executing AI services based on virtual infrastructures according to an embodiment of the present disclosure.

The method for executing AI services based on virtual infrastructures according to an embodiment of the present disclosure may be performed by an AI service execution apparatus, such as a computing device or a server. Also, the method for executing AI services based on virtual infrastructures according to an embodiment of the present disclosure may be performed using a computing server cluster.

Referring to FIG. 2, the method for executing AI services based on virtual infrastructures according to an embodiment of the present disclosure includes configuring the sharing type of a computational processing unit at step S110, executing an AI service based on a virtual infrastructure using requirements for the AI service and information about the sharing type of the computational processing unit at step S120, and performing optimization for the AI service at step S130.

Here, the sharing type of the computational processing unit may include a type in which the resource of the computational processing unit is shared by multiple virtual infrastructures and a type in which virtual computational processing units are generated by partitioning the resource of the computational processing unit.

Here, the sharing type of the computational processing unit may include a first type in which the entire computational processing unit supports AI services of multiple virtual infrastructures, a second type in which the entire computational processing unit supports AI services of multiple virtual infrastructures but the AI services of the multiple virtual infrastructures are integrated into a single context, a third type in which multiple virtual computational processing units are generated by partitioning the memory of the computational processing unit, and a fourth type in which multiple virtual computational processing units are generated by partitioning the memory and cores of the computational processing unit.

Here, the requirements for the AI service may include information about a resource of a computational processing unit, information about the model of the AI service, information about the type of a virtual infrastructure, and whether isolated execution is required.

Here, the type of the virtual infrastructure may include a virtual machine or a container.

Here, performing the optimization at step S130 may comprise performing optimization for partitioning of the computational processing unit, a batch size, a combination of AI models to be simultaneously executed, and the sharing type of the computational processing unit.

Here, executing the AI service at step S120 may comprise inserting the AI service into a ready queue when a resource of a computational processing unit satisfying the requirements for the AI service is not present.

Here, performing the optimization at step S130 may comprise determining whether to perform optimization based on the utilization rate of the computational processing unit or whether an AI service waiting in the ready queue is present.

Here, performing the optimization at step S130 may comprise performing AI service migration and, when necessary, changing the sharing type of the computational processing unit.

Here, performing the optimization at step S130 may comprise, when the utilization rate of the computational processing unit is greater than a first threshold value, redeploying the AI service being executed on the computational processing unit on another computational processing unit.

Here, performing the optimization at step S130 may comprise, when the throughput of AI services simultaneously being executed on the computational processing unit is less than a second threshold value, performing migration of the AI service.

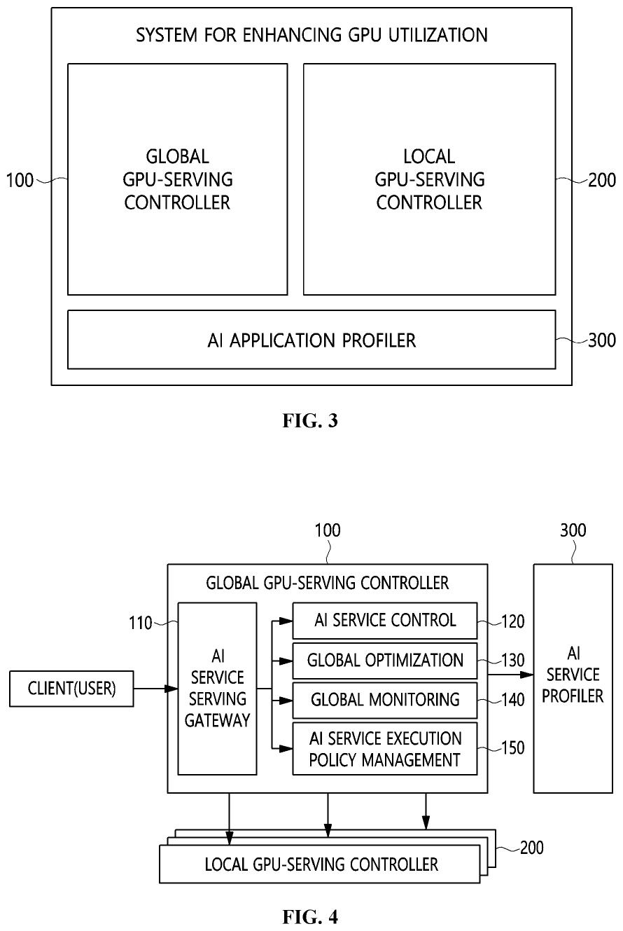

FIG. 3 is a block diagram illustrating an apparatus for enhancing GPU utilization according to an embodiment of the present disclosure.

Referring to FIG. 3, an apparatus (system) for enhancing GPU utilization according to the present disclosure includes a global GPU-serving controller 100, a local GPU-serving controller 200, and an AI service profiler 300.

Here, the global GPU-serving controller 100 and the AI service profiler 300 may be executed by being deployed in the same computing server or in different computing servers. The local GPU-serving controller 200 may be executed by being deployed in each computing server in a cluster for executing an AI service.

FIG. 4 is a block diagram illustrating a global GPU-serving controller in detail.

Referring to FIG. 4, a user (client) may request AI service control, global optimization, global monitoring, and AI service execution policy management through the AI service serving gateway unit 110 of a global GPU-serving controller block.

An AI service control unit 120 may execute an AI service based on a virtual infrastructure such as a container or a virtual machine. Also, the AI service control unit 120 may have functions for interrupting, resuming, and deleting an AI service. The AI service may be executed by selecting a specific GPU in a computing server, in which the service is to be deployed, through a global optimization unit and by making a request to execute the AI service to the local GPU-serving controller of the corresponding computing server node. Then, information about execution of the AI service is stored through an AI service execution policy management unit 150.

Similarly, requests to interrupt, resume, and delete the AI service are processed by sending the requests to the local GPU-serving controller of the computing server in which the corresponding AI service is being executed, after which relevant information may be reflected through AI service execution policy management. Meanwhile, when there is no GPU having an available resource capable of executing an AI service, the AI service may be inserted into a ready queue through the AI service execution policy management unit 150 in order to execute the AI service when a GPU having a free resource is available.

The global optimization unit 130 may process a request from the AI service control unit to select a computing server and a GPU on which an AI service is to be deployed and may then return a result value. When it selects the computing server and the GPU, an AI service execution requirement specification is required, and the returned result value may include the type of the sharing policy of the GPU. The AI service execution requirement specification may be acquired by receiving the same from a user or through the AI service execution policy management unit and an AI service profiler.

The AI service execution requirement specification may include resource information such as the number of CPU cores, the amount of memory, the amount of memory of a GPU, and the like, and may further include the AI model used in the AI service, a virtual infrastructure type, information about whether isolated execution is ensured, a batch size, latency, optimal AI models suitable to be simultaneously executed, and the like. Here, the virtual infrastructure type may be set to either a container or a virtual machine, and the information about whether isolated execution is ensured may include whether a virtual GPU instance is allocated through the isolation of a resource such as memory in a GPU and compute cores.

The global optimization unit 130 may select the GPU of a specific computing server having an available resource and satisfying execution requirements based on 1) the execution requirements for the AI service to be executed, 2) information about the AI service being executed in the cluster, which is acquired through the AI service execution policy management unit, 3) information about resource usage acquired through a global monitoring unit, and the like.

Meanwhile, when it reaches a preset specific time, when a user makes a request, or when a specific condition is satisfied, the global optimization unit 130 may migrate the AI service being executed in order to raise the utilization rate of the GPU resources of computing servers in a cluster. Examples of the specific condition may include the case in which analysis and inference based on the AI service are requested, the case in which the GPU utilization rate is lower than a specific threshold, the case in which an AI service required to be executed is present (a service is present in the ready queue), and the like, and the specific condition may be variously defined depending on the user or the service.

Migration of AI services enables fragmented GPU resources to be collected from multiple GPUs and enables larger-scale available resources of the GPUs to be configured by changing the sharing policy type of the GPUs, whereby the AI service, the execution requirements of which are satisfied, among the AI services in the ready queue of the AI service execution policy management unit, may be additionally executed. Accordingly, the overall utilization rate of the GPUs in the cluster may be raised.

A global monitoring unit 140 collects and manages monitoring information pertaining to the resource usage and a service state in each computing server through the local GPU-serving controller block.

The AI service execution policy management unit 150 manages information about requirements for executing an AI service and information about the current execution of an AI service. Furthermore, requirements for AI service execution may be acquired by receiving a request from a user, and this may be performed through the AI service profiler. The acquired requirements may include information about optimal resources required for execution, such as the number of CPU cores, the amount of memory, the amount of memory of a GPU, and the like, and may further include the optimal batch size for execution of the AI service, the latency depending on the batch size, optimal AI models that are suitable to be simultaneously executed, and the like.

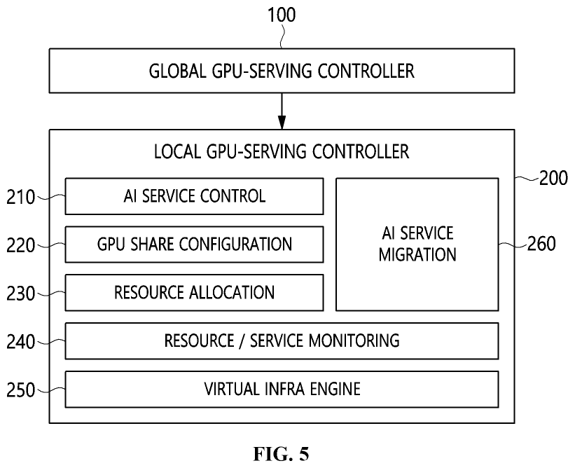

FIG. 5 is a block diagram illustrating a local GPU-serving controller in detail.

Referring to FIG. 5, the local GPU-serving controller 200 has six function units.

An AI service control unit 210 controls execution of an AI service requested by the global GPU-serving controller block. The AI service is executed by configuring a virtual infrastructure instance through a virtual infrastructure engine 250 based on information about resources such as a CPU, memory, and the like and on the virtual infrastructure image of the AI service, a GPU sharing policy, and resource information received from the global GPU-serving controller. Interrupting the AI service being executed or resuming or deleting the interrupted AI service is also processed through the virtual infrastructure engine 250. Particularly, when the AI service is executed, the AI service control unit 210 retrieves the current sharing policy of the GPU and the sharing policy requested by a GPU share configuration unit and changes (reconfigures) the sharing policy when the requested sharing policy differs from the current sharing policy. Then, resources excluding the GPU are selected and allocated for execution of the AI service through a resource allocation unit 230.

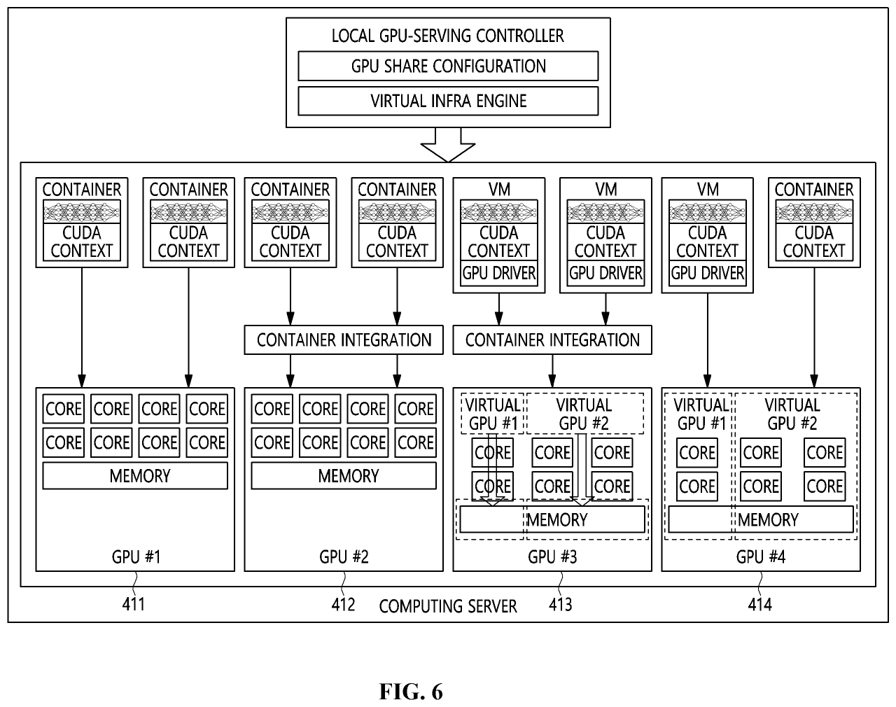

The GPU share configuration unit 220 configures and manages the sharing policy of a corresponding GPU in response to a request from the AI service control unit or an AI service migration unit. The GPU sharing policy will be described in detail with reference to FIG. 6.

The resource allocation unit 230 selects and allocates resources other than a GPU, such as a CPU, memory, storage, and the like, for AI services. Here, a resource utilization rate and service monitoring information from a resource/service monitoring unit 240 may be referred to.

The resource/service monitoring unit 240 monitors performance factors, such as the utilization rate of each resource, the average number of service requests, latency, and the like, in real time. It may transfer the average, the maximum value, the minimum value, and the like in a specific time unit in response to a request from the resource allocation unit 230, and may transfer resource and service monitoring information to the global GPU-serving controller 100 in real time.

The virtual infrastructure engine unit 250 dynamically configures a virtual machine or a container and executes and controls an AI service.

The AI service migration unit 260 performs a task for extracting, transforming, and storing information and data of the service to be migrated in response to a request from the global GPU-serving controller and a task for loading the information and data of the service in order to execute the service to be migrated. The migration of the AI service may be supported when the service is interrupted or when the service is running (in a live state). In the process of migrating the AI service, it may be necessary to change the sharing policy of a specific GPU through the GPU share configuration unit.

FIG. 6 is a view illustrating a GPU sharing policy.

Referring to FIG. 6, a GPU sharing policy may be configured such that each GPU has a single sharing type, and includes a method for sharing memory and all of compute cores, which are internal resources of the GPU, and a method for configuring virtual GPU instances by separating internal resources of the GPU into isolated smaller parts. Each of these methods may be categorized into two different sharing methods, and these sharing methods are named GPU sharing type 1, GPU sharing type 2, GPU sharing type 3, and GPU sharing type 4 from the left of FIG. 6.

GPU sharing type 1 (411) has a structure in which multiple containers execute AI services on the same GPU and in which the AI service using the GPU memory and the compute cores is determined by the scheduler in the GPU. That is, because the respective containers executing the AI services occupy the GPU resource in different times, a context switch occurs whenever the container is changed.

GPU sharing type 2 (412) has the same concept as GPU sharing type 1, that is, has a structure in which multiple containers execute AI services on the same GPU, but is different from GPU sharing type 1 in that Compute Unified Device Architecture (CUDA) contexts of the multiple containers are integrated into a single context (context integration) and delivered to the GPU scheduler so as to be recognized as a single context by the GPU scheduler. As a result, a context switch does not occur. Compared to GPU sharing type 1 (411), GPU sharing type 2 (412) may reduce the waiting time of the AI service and improve throughput thereof.

GPU sharing type 3 (413) is configured to generate multiple virtual GPUs by partitioning the memory of a GPU into small segments. Here, the virtual GPU may be allocated to a virtual machine, and a number of compute cores proportional to the actual physical memory size may be allocated to the virtual GPU by default. However, when the AI service executed on the virtual machine requests more cores, more compute cores may be allocated through virtual machines integration (VM integration). Here, VM integration may be implemented by allocating compute cores in a time-sharing manner in response to requests for the compute cores from the multiple virtual machines. That is, the memory segments of the virtual GPUs are isolated by separating the same, but the compute cores may be shared by the multiple virtual GPUs in a time-sharing manner.

GPU sharing type 4 (414) is configured to generate multiple isolated virtual GPUs by partitioning GPU memory into small segments and dividing compute cores. A single virtual GPU may be allocated to and used by a single virtual machine or may be allocated to multiple containers to be shared and used.

The GPU sharing type may be configured and changed by the GPU share configuration unit 220 of the local GPU-serving controller, and the virtual infrastructure engine may generate, execute, interrupt, resume, and delete a virtual machine or a container depending on the GPU sharing type.

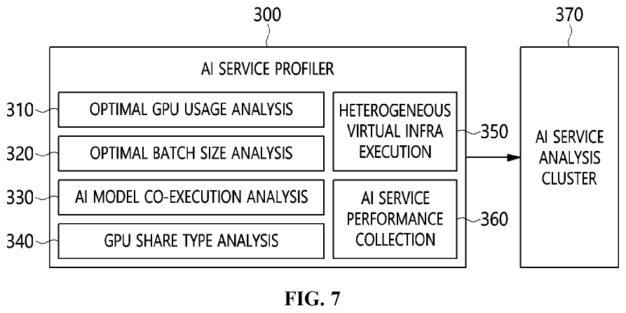

FIG. 7 is a block diagram illustrating an AI service profiler in detail.

The AI service profiler 300 may perform four types of analysis. An optimal GPU usage analysis unit 310 partitions a single piece of GPU memory and compute cores into 25%, 50%, 100%, or the like, allocates the partitioned GPU memory and compute cores, and measures AI service latency. Then, it determines the minimum GPU resource size when the measured latency is shortest.

An optimal batch size analysis unit 320 analyzes a batch size that satisfies target latency and throughput in service level objectives (SLO) through batch processing of collected AI service inference requests. When there is no SLO, batch size information for the minimum latency and the maximum throughput is searched for.

An AI model co-execution analysis unit 330 analyzes a combination of two AI services that satisfies the condition in which the throughput of each of the AI services decreases by less than 25% or the overall throughput increases to be equal to or higher than 150% when the two AI services having different AI models are simultaneously executed. For example, when Long Short-Term Memory (LSTM) and Visual Geometry Group (VGG) are simultaneously executed, the throughput of the VGG and the throughput of the LSTM decrease by about 18% and 65%, respectively, and the overall throughput increases by 10%. However, when the LSTM is executed simultaneously with a super-resolution (SR) model, the throughput of the LSTM and the throughput of the SR model decrease by 17% and 0%, respectively, and the overall throughput becomes 183%. This shows the degree of interference occurring when a GPU processes different models. Accordingly, it can be seen that, when it is necessary to simultaneously execute an LSTM model and another model by sharing a single GPU, the SR model is a better choice than the VGG.

A GPU share type analysis unit 340 analyzes service performance by executing two services, which are determined to form an optimal combination to be simultaneously executed as the result of AI model co-execution analysis, based on four GPU sharing types.

The above-described four types of analysis may be performed by executing AI services in the form of a virtual machine and a container based on a heterogeneous virtual infrastructure execution unit 350. The heterogeneous virtual infrastructure execution unit dynamically configures an environment for service execution, including GPU sharing type configuration and GPU resource allocation. An AI service performance collection unit 360 collects information about the performance of the AI services run by executing the heterogeneous virtual infrastructures. Here, the AI service may be executed in a computing server in a separately constructed AI service analysis cluster, and alternatively, part of the computing server in which the local GPU-serving controller is executed may be used depending on the circumstances. That is, the environment may be variously configured depending on the operation policy of the cluster.

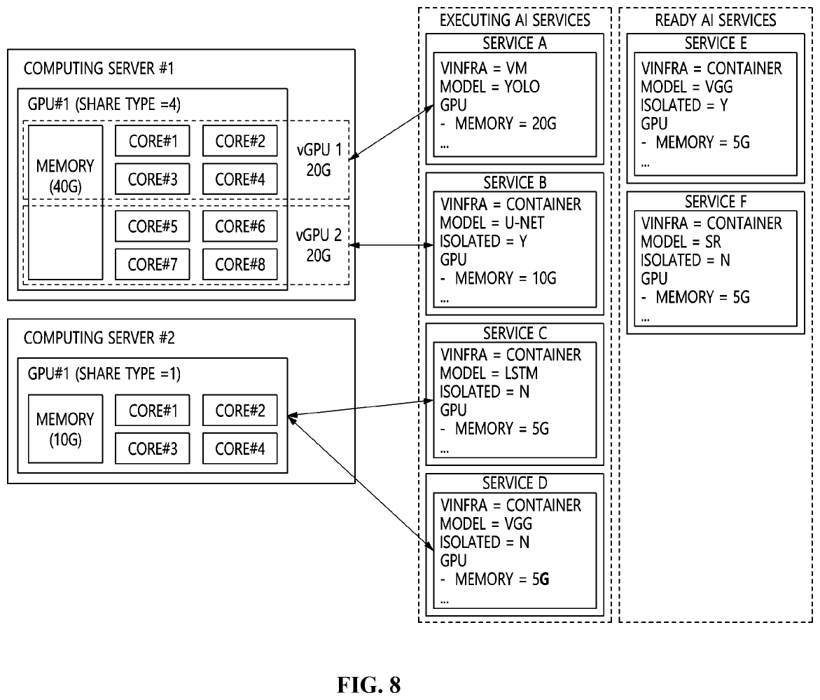

FIG. 8 is an example of AI service execution based on GPU sharing.

Referring to FIG. 8, when a request to execute an AI service is received, a GPU sharing type is set depending on GPU resource requirements. In the present disclosure, a local GPU-serving controller sets a GPU sharing type before executing an AI service based on a specific GPU. Setting the GPU sharing type includes generating a virtual GPU. Particularly, when the AI service is executed on a virtual machine (vInfra=VM) or when the AI service requires guarantee of isolated execution even though it is executed based on a container (Isolated=Y), the GPU sharing type is set to 3 or 4, and smaller virtual GPUs may be generated after partitioning the internal resources of a GPU. In FIG. 8, the sharing type of GPU #1 installed in computing server #1 is set to 4 in order to execute AI service A that requires 200 gigabytes (GB) of GPU memory, whereby two virtual GPUs, that is, vGPU 1 and vGPU 2, each having 20 GB of memory, are generated. Then, vGPU 1 is allocated to AI service A based on a VM. Similarly, because AI service B requires guarantee of isolated execution (Isolated=Y) although it is executed based on a container, it is necessary to allocate a virtual GPU, and vGPU 2 in computing server #1 is allocated thereto. Because AI service C (GPU memory=5 GB) and AI service D (GPU memory=5 GB) do not require isolated execution, containers are generated on GPU #1 having 10 GB of memory in computing server #2, and the AI services are executed. That is, the sharing type of GPU #1 of computing server #2 is set to 1.

AI service E requires guarantee of isolated execution, but an available virtual GPU is not present. Accordingly, AI service E is inserted into the ready queue of the AI service execution policy management unit, and AI service F is also inserted into the ready queue because 5 GB of GPU memory, which is the requirement for execution thereof, is not available.

The global optimization unit of the global GPU-serving controller block performs a global optimization task in order to raise the utilization of a GPU in a cluster. Global optimization is triggered when there is no available GPU resource although AI services are present in the ready queue of the AI service execution policy management unit. The global optimization includes changing the sharing type of a specific GPU, changing the detailed configuration, and migrating an AI service. Particularly, when there is no available GPU resource, the AI services being executed by sharing a GPU, the utilization rate of which is equal to or greater than 90% or is equal to or less than 50%, in a cluster (the GPU sharing type set to 1 or 2) may be the target to be migrated. The purpose of AI service migration is to execute the AI services, the AI models of which can be optimally executed when they are simultaneously executed, by sharing the same GPU. Because the global optimization is time-consuming, it may be performed when a small number of requests are made.

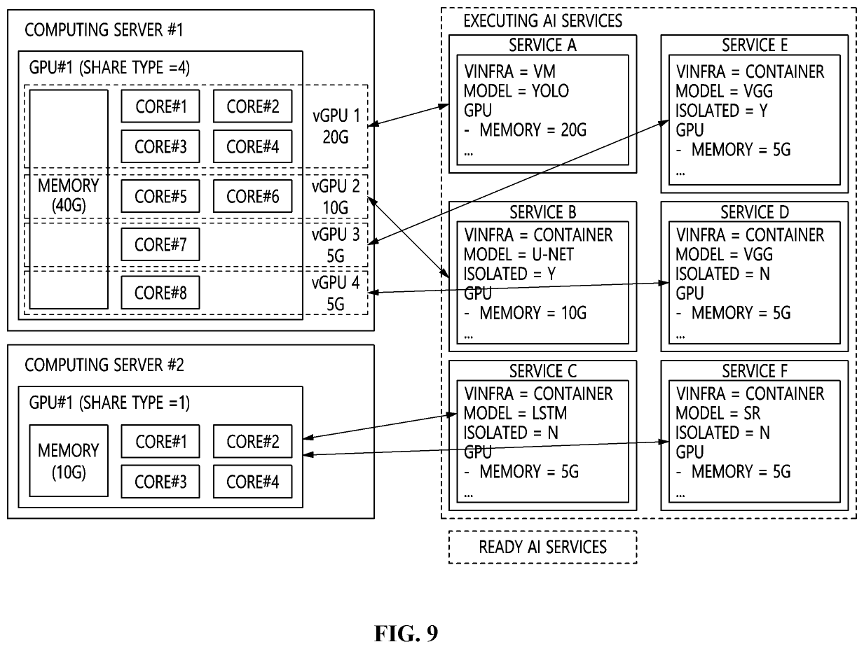

FIG. 9 is an example of execution of AI services based on GPU sharing after global optimization.

FIG. 9 illustrates execution of AI services after global optimization according to the present disclosure is performed in the state illustrated in FIG. 8. First, in order to execute service E that is required to be executed on a virtual GPU, the GPU sharing type of GPU #1 of computing server #1 is reconfigured. In FIG. 9, vGPUs 1, 2, 3, and 4 having 20 GB, 10 GB, 5 GB, and 5 GB of memory, respectively, are generated in order to guarantee execution of AI services A, B, and E. Then, vGPU 1, vGPU 2, and vGPU 3 are allocated to AI service A, AI service B, and AI service E, respectively, whereby AI service A, AI service B, and AI service E are executed. In order to execute AI service F, a GPU having 5 GB of memory is required. Here, it is checked whether there is a case in which the GPU sharing type is 1 or 2 and the GPU utilization rate of simultaneously executed AI services is too high or low or a case in which the service throughput decreases below 50%. When LSTM and VGG models are simultaneously executed, the throughput of the LSTM decreases to 65% due to high interference. Because the LSTM model forms the optimal combination with the SR model when they are simultaneously executed, AI service D of the VGG model is migrated from computing server #2 to computing server #1. Accordingly, AI service D is executed on vGPU 4 of computing server #1, and AI service F and AI service C are simultaneously executed in computing server #2.

According to the present disclosure, when AI services of heterogeneous AI inference model types are simultaneously executed, an optimal combination capable of minimizing performance degradation and increasing throughput is formed through an AI service profiler, and the optimal combination of AI services may be deployed and executed by sharing the same GPU. Here, the AI services may be of heterogeneous virtual infrastructure types, such as a virtual machine and a container.

Also, according to the present disclosure, the sharing type of each GPU installed in a computing server may be dynamically set to one of four sharing types, and multiple AI services may be executed by sharing the GPU. Furthermore, global optimization of a system for enhancing GPU utilization enables GPU resources required for AI services to be partitioned to have optimal sizes and enables reconfiguration of the GPU sharing type, thereby enabling more AI services to be executed.

Also, according to the present disclosure, fragmented GPU resources are collected and dynamically reconfigured to form a larger-scale available resource through AI service migration, which is one of global optimization tasks. Based thereon, AI services may be redeployed to form an optimal combination and then be executed, whereby the utilization rate of the GPU and the throughput of the services may be improved.

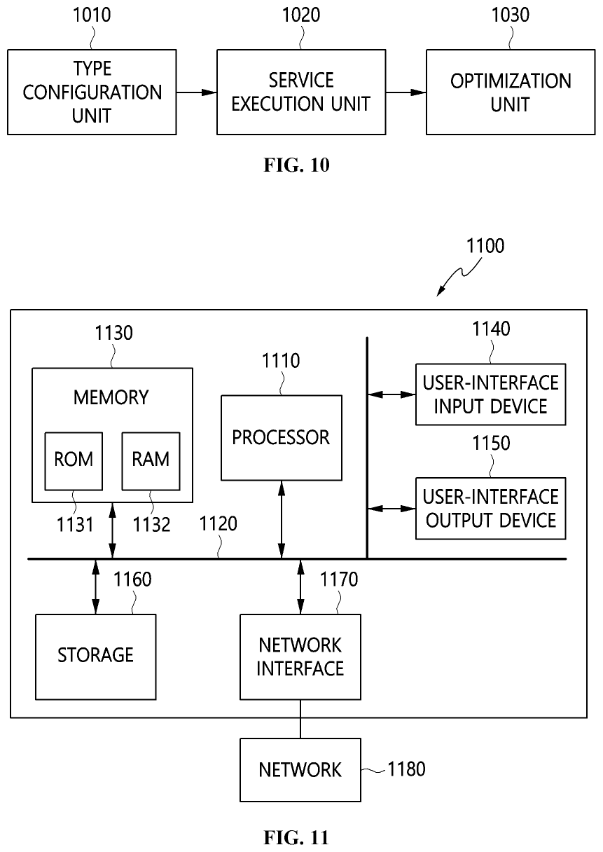

FIG. 10 is a block diagram illustrating an apparatus for executing AI services based on virtual infrastructures according to an embodiment of the present disclosure.

The apparatus for executing AI services based on virtual infrastructures according to an embodiment of the present disclosure includes a type configuration unit 1010 for configuring a sharing type of a computational processing unit, a service execution unit 1020 for executing an AI service based on a virtual infrastructure using requirements for the AI service and information about the sharing type of the computational processing unit, and an optimization unit 1030 for performing optimization for an AI service being executed.

Here, the sharing type of the computational processing unit includes a type in which the resource of the computational processing unit is shared by multiple virtual infrastructures and a type in which virtual computational processing units are generated by partitioning the resource of the computational processing unit.

Here, the sharing type of the computational processing unit may include a first type in which the entire computational processing unit supports AI services of multiple virtual infrastructures, a second type in which the entire computational processing unit supports AI services of multiple virtual infrastructures but the AI services of the multiple virtual infrastructures are integrated into a single context, a third type in which multiple virtual computational processing units are generated by partitioning the memory of the computational processing unit, and a fourth type in which multiple virtual computational processing units are generated by partitioning the memory and cores of the computational processing unit.

Here, the requirements for the AI service may include information about resources of a computational processing unit, information about the model of the AI service, information about the type of a virtual infrastructure, and whether isolated execution is required.

Here, the type of the virtual infrastructure may include a virtual machine or a container.

Here, the optimization unit 1030 may perform optimization for partitioning of the computational processing unit, a batch size, a combination of AI models to be simultaneously executed, and the sharing type of the computational processing unit.

Here, the service execution unit 1020 may insert the AI service into a ready queue when a resource of a computational processing unit satisfying the requirement for the AI service is not present.

Here, the optimization unit 1030 may determine whether to perform optimization based on the utilization rate of the computational processing unit or whether an AI service waiting in the ready queue is present.

Here, the optimization unit 1030 performs AI service migration, and may change the sharing type of the computational processing unit when necessary.

Here, when the utilization rate of the computational processing unit is greater than a first threshold value, the optimization unit 1030 may redeploy the AI service being executed on the computational processing unit on another computational processing unit.

Here, when the throughput of AI services simultaneously being executed on the computational processing unit is less than a second threshold value, the optimization unit 1030 may perform migration of the AI service.

FIG. 11 is a view illustrating the configuration of a computer system according to an embodiment.

The apparatus for executing AI services based on virtual infrastructures according to an embodiment may be implemented in a computer system 1100 including a computer-readable recording medium.

The computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected with a network 1180. The processor 1110 may be a central processing unit or a semiconductor device for executing a program or processing instructions stored in the memory 1130 or the storage 1160. The memory 1130 and the storage 1160 may be storage media including at least one of a volatile medium, a nonvolatile medium, a detachable medium, a non-detachable medium, a communication medium, or an information delivery medium, or a combination thereof. For example, the memory 1130 may include ROM 1131 or RAM 1132.

According to the present disclosure, an optimal GPU sharing policy may be established by detecting the amount of resources required for executing AI services, whereby a utilization rate may be increased.

Also, the present disclosure may increase the utilization rate of a GPU by making an optimal combination when multiple AI services are executed.

Specific implementations described in the present disclosure are embodiments and are not intended to limit the scope of the present disclosure. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present disclosure should not be construed as being limited to the above-described embodiments, and the entire scope of the appended claims and their equivalents should be understood as defining the scope and spirit of the present disclosure.

What is claimed is:

1. A method for executing Artificial Intelligence (AI) services based on virtual infrastructures using a cluster of computing servers, comprising:
configuring a sharing type of a computational processing unit;
executing an AI service based on a virtual infrastructure using requirements for the AI service and information about the sharing type of the computational processing unit; and
performing optimization for the AI service.

2. The method of claim 1, wherein the sharing type of the computational processing unit includes a type in which a resource of the computational processing unit is shared by multiple virtual infrastructures and a type in which virtual computational processing units are generated by partitioning the resource of the computational processing unit.

3. The method of claim 1, wherein the sharing type of the computational processing unit includes
a first type in which the entire computational processing unit supports AI services of multiple virtual infrastructures,
a second type in which the entire computational processing unit supports AI services of multiple virtual infrastructures but the AI services of the multiple virtual infrastructures are integrated into a single context,
a third type in which multiple virtual computational processing units are generated by partitioning memory of the computational processing unit, and
a fourth type in which multiple virtual computational processing units are generated by partitioning the memory and cores of the computational processing unit.

4. The method of claim 1, wherein the requirements for the AI service include information about a resource of a computational processing unit, information about a model of the AI service, information about a type of a virtual infrastructure, and whether isolated execution is required.

5. The method of claim 1, wherein a type of the virtual infrastructure includes a virtual machine or a container.

6. The method of claim 1, wherein performing the optimization comprises performing optimization for partitioning of the computational processing unit, a batch size, a combination of AI models to be simultaneously executed, and the sharing type of the computational processing unit.

7. The method of claim 1, wherein executing the AI service comprises inserting the AI service into a ready queue when a resource of a computational processing unit satisfying the requirements for the AI service is not present.

8. The method of claim 7, wherein performing the optimization comprises determining whether to perform optimization based on a utilization rate of the computational processing unit and whether an AI service waiting in the ready queue is present.

9. The method of claim 6, wherein performing the optimization comprises performing AI service migration and, when necessary, changing the sharing type of the computational processing unit.

10. The method of claim 7, wherein performing the optimization comprises, when a utilization rate of the computational processing unit is greater than a first threshold value, redeploying an AI service being executed on the computational processing unit on another computational processing unit.

11. The method of claim 1, wherein performing the optimization comprises, when throughput of AI services simultaneously executed on the computational processing unit is less than a second threshold value, performing migration of the AI service.

12. An apparatus for executing Artificial Intelligence (AI) services based on virtual infrastructures, comprising:
a type configuration unit for configuring a sharing type of a computational processing unit;
a service execution unit for executing an AI service based on a virtual infrastructure using requirements for the AI service and information about the sharing type of the computational processing unit; and
an optimization unit for performing optimization for the AI service being executed.

13. The apparatus of claim 12, wherein the sharing type of the computational processing unit includes a type in which a resource of the computational processing unit is shared by multiple virtual infrastructures and a type in which virtual computational processing units are generated by partitioning the resource of the computational processing unit.

14. The apparatus of claim 12, wherein the sharing type of the computational processing unit includes
a first type in which the entire computational processing unit supports AI services of multiple virtual infrastructures,
a second type in which the entire computational processing unit supports AI services of multiple virtual infrastructures but the AI services of the multiple virtual infrastructures are integrated into a single context,
a third type in which multiple virtual computational processing units are generated by partitioning memory of the computational processing unit, and
a fourth type in which multiple virtual computational processing units are generated by partitioning the memory and cores of the computational processing unit.

15. The apparatus of claim 12, wherein the requirements for the AI service include information about a resource of a computational processing unit, information about a model of the AI service, information about a type of a virtual infrastructure, and whether isolated execution is required.

16. The apparatus of claim 12, wherein a type of the virtual infrastructure includes a virtual machine or a container.

17. The apparatus of claim 12, wherein the optimization unit performs optimization for partitioning of the computational processing unit, a batch size, a combination of AI models to be simultaneously executed, and the sharing type of the computational processing unit.

18. The apparatus of claim 12, wherein the service execution unit inserts the AI service into a ready queue when a resource of a computational processing unit satisfying the requirements for the AI service is not present.

19. The apparatus of claim 18, wherein the optimization unit determines whether to perform optimization based on a utilization rate of the computational processing unit and whether an AI service waiting in the ready queue is present.

20. A method for executing Artificial Intelligence (AI) services based on virtual infrastructures using a cluster of computing servers, comprising:
executing AI services based on virtual infrastructures using requirements for the AI services and information about a combination of AI models to be simultaneously executed; and
performing optimization for the AI services,
wherein:
the information about the combination of the AI models to be simultaneously executed includes information about throughput of each of the AI models when the multiple AI models are simultaneously executed.
